(19) United States
(12) Patent Application Publication
(10) Pub. No.: US 2008/0195546 A1
(43) Pub. Date: Aug. 14, 2008

(54) MULTILEVEL DISTRIBUTION OF DIGITAL CONTENT

(75) Inventor: Andrea Lilley, Cheshire (GB)

Correspondence Address: WARREN A. SKLAR (SOER);RENNER, OTTO, BOISSELLE & SKLAR, LLP, 1621 EUCLID AVENUE, 19TH FLOOR, CLEVELAND, OH, 44115, US

(73) Assignee: SONY ERICSSON MOBILE COMMUNICATIONS AB, Lund (SE)

(21) Appl. No.: 11/673,636

(22) Filed: Feb. 12, 2007

(51) Int. Cl. H04K 1/00; G06Q 30/00

(52) U.S. Cl. 705/59; 705/14

(57) ABSTRACT

Disclosed is a system and method for earning award points for distributing electronic digital content between electronic equipment. Digital content (protected and un-protected) is stored on a remote distribution server for transmission to receiving electronic equipment (e.g., portable communications devices including mobile telephones, computers, etc.). The digital content generally includes a header having one or more digital rights management fields for allowing access to the digital content based upon a content provider's preferences. Prior to the operator of the receiving electronic equipment distributing the digital content to one or more other electronic equipment, a unique identifier associated with the receiving electronic equipment is inserted in one or more of the digital rights management fields of the digital content. The digital content is then distributed containing the unique identifier. An identification associated with the digital content and the unique identifier associated with the receiving electronic equipment is transmitted to a provider upon distribution of the license for maintaining at least an awards program based on distribution of the digital content.

### TECHNICAL FIELD OF THE INVENTION

The present invention relates to electronic distribution of digital content to third parties over networks and, more particularly, to a system and method for rewarding distribution of such content.

### DESCRIPTION OF THE RELATED ART

Digital content providers commonly sell digital content over networks (e.g., the Internet, mobile telephony networks, etc.). Conventionally, such digital content includes, for example, music, images, video, books, games and ring tones. Distributing digital content over networks may be prohibitive due to the ease that the digital content may be copied, altered and/or transmitted to other unauthorized users. In order to prevent revenue loss due to such unauthorized activities, digital content providers commonly implement digital rights management (DRM) strategies with the disseminated digital content.

It is well known that DRM strategies can be used to protect digital content and control their distribution and use. In general, DRM utilizes digital licenses to control and/or otherwise limit access to digital content. For example, instead of buying the desired digital content, the consumer purchases a digital license granting certain prescribed rights to the digital content. Typically, a digital license is a digital data file that specifies certain usage permissions for the digital content conferred to the user. Usage permissions can be defined by a wide range of criteria. Common usage permissions include: frequency of access to the digital content, an expiration date, restriction of transfer to other devices, copy permission, etc. Various business models can be implemented based upon the DRM strategy implemented. For example, lease rental, subscription, try-before-buy, pay-per-use, etc.

Protected digital content can be distributed from a distributor, which may be the operator/content provider, and/or user to another user by a variety of manners including, for example, making an electronic copy and e-mailing the digital content, sending the digital content as an attachment or making the digital content available for download on a network, etc. Generally, digital content and licenses are stored separately, which makes the system more flexible in a way that protected content can be freely distributed amongst users and license requests can take place later. Therefore, whoever receives the protected digital content, without a digital license, will be unable to render the digital content. The receiver of the digital content will generally be required to obtain his or her own digital license from the appropriate source in order to properly render the digital content.

A conventional DRM system 10 is illustrated in FIG. 1. The DRM system 10 generally includes a digital content provider 12, a distributor 14, a consumer 16 and a clearinghouse 18. Although each of these entities has been shown as separate entities, one entity may also serve multiple functions. For example, the clearinghouse 18 may be the same entity as the content provider 12 and/or distributor 14. The digital content provider 12 may be, for example, a music record label, a movie studio, a ring tone developer, a service provider, an operator, etc. The digital content provider 12 generally holds the digital rights of the digital content (i.e., owns the copyright to the digital content). A primary goal of the digital content provider 12 is to obtain wide distribution of the digital content and, at the same, protect the digital rights of the content.

The distributor 14 provides distribution channels, such as for example, an Internet website, a portal, a telephony kiosk, etc. The distributor 14 typically receives the digital content from the content provider 12 and establishes a marketing strategy and distribution channels for promotion of the digital content. The consumer 16 consumes the digital content by retrieving downloadable or streaming content through the distribution channel. Generally, once the consumer 16 downloads the desired digital content, the consumer then pays for the associated digital license. The application used by the consumer to render the digital content generally initiates a license request to the clearinghouse 18. The clearinghouse 18 handles the financial transaction for issuing the digital license to the consumer 16 and pays royalty fees to the content provider 12 and distribution fees to the distributor 14 accordingly. The clearinghouse 18 is also generally responsible for logging license consumptions for every consumer 16.

A conventional DRM system 10 generally operates in the following manner. The content provider 12 encodes the digital content into the format supported by the DRM system 10. The digital content is then encrypted and packaged for the preparation of distribution. The content provider 12 may use watermarking technology to embed digital codes into the digital content that can identify the ownership of the content and the usage permissions. The protected content may then be transferred to the distributor 14. Transfer of digital content generally involves an electronic transfer of the digital content from the content provider 12 to an appropriate content distribution server, for example, a web server, a telephony server or a streaming server, etc. for on-line distribution of the digital content.

A digital license containing content rights and usage permissions for the protected digital content is sent to the clearinghouse 18 from the content provider 12. The usage permissions generally specify how the content should be used, such as copy permission, pay-per-view, time constrained, sample, etc.

The consumer 16 desiring to download the digital content may download the digital content from the distributor 14 (e.g., storage server, request access from the telephony server, request streaming content from the streaming server, etc.). To be able to consume or otherwise render the protected content, the user generally requests a valid digital license from the clearinghouse 18. After receiving the license request, the clearinghouse 18 generally verifies the user's identity for example by having the user present a valid digital certificate, charges the user's account based on the content usage permissions, and generates transaction reports to the content provider 12. Finally, the digital license is delivered to the consumer's device after the consumer has paid through an appropriate e-commerce system and/or pay for the download through their invoice/subscription with the content provider 12, and the protected content can be decrypted and used or otherwise rendered according to the usage permissions in the license.

Under this system 10, consumer 16 may pass along received digital content to other consumers through superdistribution, which lets vendors market their digital content to a vast amount of potential customers without direct involvement. Although digital content can be freely distributed, the content is generally encrypted and to render the content, the recipient has to contact the clearinghouse and provide the necessary information and/or payment required to obtain the digital license.

There are a variety of alterations that may be made to the above system. For instance, the digital license can be delivered to the requesting application prior to or at the same time as the transfer of digital content. This could apply to temporary licensing for promotional purposes. For example, a temporary license specifying a three-time access for a piece of digital music could be pre-delivered with the media, allowing the consumer to listen to the music three times and then making decision to request and paying for a permanent license allowing unlimited accesses. Some companies offer ‘try-before-buy’ business model that directs the consumer to the clearinghouse where a permanent license can be purchased after the temporary license expires.

The consumer applications that generally render the digital content, such as for example, digital content viewers, players or readers, generally play a significant role in DRM implementation. The applications generally enforce protection of digital content on the basis of the digital license. Most content providers extend existing viewers without DRM functionalities through the use of application plug-ins, which essentially makes those applications become integral components of DRM systems. In this approach, the content provider usually uses a special file extension to identify digital content protected by a specific DRM system. Through a particular plug-in, the content viewer opens and decrypts the digital content based on the usage permissions in the license. Generally each DRM system uses its own proprietary approach and there is no interoperability between application extensions and plug-ins. Digital content protected by one DRM system also generally cannot be accessed by the client-side application in another DRM system. To access various digital content provided by multiple DRM systems, the consumer has to install different plug-ins and vendor-specific applications.

One drawback with conventional DRM systems is that there is a lack of incentive for consumers to distribute digital content to other consumers. Another drawback with conventional DRM systems is that it is difficult to reward a particular consumer for distributing digital content to other consumers.

### SUMMARY

One aspect of the present invention provides for encouraging consumers to distribute digital content to other consumers for personal gain. Another aspect of the present invention is to reward individual distributions for distributing digital content to other consumers.

One aspect of the invention relates to a method for earning an award for distributing electronic content between electronic equipment, the method comprising: receiving digital content from an associated electronic source by a receiving electronic equipment, wherein the digital content includes a header having one or more digital rights management fields; inserting a unique identifier associated with the receiving electronic equipment in one or more of the digital rights management fields of the digital content; distributing the digital content containing the unique identifier to one or more electronic equipment; and transmitting an identification associated with the digital content and the unique identifier associated with the receiving electronic equipment to a provider upon distribution of the digital content, wherein the provider maintains a record of a number of times the digital content was distributed and the unique identifier associated with distributing the digital content for an awards program based at least in part on distribution of the digital content.

Another aspect of the invention relates to the digital content being at least one selected from the group consisting of: a music file, an image file, a video file, an electronic book file, an electronic video game, a ring tone file.

Another aspect of the invention relates to the digital content being an advertisement for a product and/or service.

Another aspect of the invention relates to the digital content being a voucher.

Another aspect of the invention relates to the receiving electronic equipment being a mobile telephone.

Another aspect of the invention relates to the digital rights management fields including a tag level and lock field in the header of the digital content to prevent further distribution of the digital content after the digital content has been forwarded a predetermined number of times and/or to prevent the user acquiring additional licenses for the media.

Another aspect of the invention relates to the digital rights management fields including a tag level and delete field in the header of the digital content to delete the digital content after the digital content has been forwarded a predetermined number of times and/or exceeded an expiration date.

Another aspect of the invention relates to award points being accumulated for selection of an award.

Another aspect of the invention relates to the award being selected from the group consisting of reduced wireless telephony service fees or reduced cost for digital content downloads.

Another aspect of the invention relates to digital content being distributed by the receiving electronic equipment and later purchased by a second receiving electronic equipment earns more awards points for the receiving electronic equipment than digital content distributed by the receiving electronic equipment.

Another aspect of the invention relates to the header of the digital content including a plurality of unique identifiers associated with electronic equipment that distributed the digital content.

Another aspect of the invention relates to each of the electronic equipment identified in the header earning reward points based at least on distribution of the digital content.

Another aspect of the invention relates to each of unique identifiers accumulating award points based on location of the unique identifier in the header of the digital content.

One aspect of the invention relates to a system for earning an award for distributing electronic content between electronic equipment, the system comprising: a server for storing digital content, wherein the digital content includes a header having one or more digital rights management fields; a plurality of electronic equipment for receiving digital content from the server, wherein at least of the plurality of electronic equipment is capable of inserting a unique identifier associated with the receiving electronic equipment in one or more of the digital rights management fields of the digital content; and a provider server communicatively coupled to the server and at least one of the electronic equipment for maintaining a record of a number of times the digital content was distributed and the unique identifier associated with distributing the digital content for an awards program based at least in part on distribution of the digital content.

Another aspect of the invention relates to the digital rights management fields including a tag level and lock field in the header of the digital content to prevent further distribution of the digital content after the digital content has been forwarded a predetermined number of times.

Another aspect of the invention relates to the digital rights management fields including a tag level and delete field in the header of the digital content to delete the digital content after the digital content has been forwarded a predetermined number of times.

Another aspect of the invention relates to award points being accumulated or selection of an award.

Another aspect of the invention relates to the header of the digital content including a plurality of unique identifiers associated with electronic equipment that distributed the digital content.

One aspect of the invention relates to a method for earning an award for distributing electronic content between electronic equipment, the method comprising: receiving digital content from an associated electronic source by a receiving electronic equipment, wherein the digital content includes a header having one or more digital rights management fields; appending a unique identifier associated with the receiving electronic equipment in one or more of the digital rights management fields of the digital content; distributing the digital content containing the unique identifier to one or more electronic equipment; transmitting an identification associated with the digital content and the unique identifier associated with the receiving electronic equipment to a provider upon distribution of the digital content, wherein the provider maintains a record of a number of times the digital content was distributed and the unique identifier associated with distributing the digital content for an awards program based at least in part on distribution of the digital content.

Another aspect of the invention relates to the digital rights management fields including a tag level and lock field in the header of the digital content to prevent further distribution of the digital content after the digital content has been forwarded a predetermined number of times.

Another aspect of the invention relates to the digital rights management fields including a tag level and lock field in the header of the digital content to delete the digital content after the digital content has been forwarded a predetermined number of times.

Another aspect of the invention relates to the awards program including awarding a predetermined amount of award points for distribution of digital content, wherein award points are accumulated for selection of an award.

Other systems, devices, methods, features, and advantages of the present invention will be or become apparent to one having ordinary skill in the art upon examination of the following drawings and detailed description. It is intended that all such additional systems, methods, features, and advantages be included within this description, be within the scope of the present invention, and be protected by the accompanying claims.

It should be emphasized that the term “comprise/comprising” when used in this specification is taken to specify the presence of stated features, integers, steps or components but does not preclude the presence or addition of one or more other features, integers, steps, components or groups thereof.”

The term “electronic equipment” includes portable radio communication equipment. The term “portable radio communication equipment”, which herein after is referred to as a mobile radio terminal includes all equipment such as mobile telephones, pagers, communicators, i.e., electronic organizers, personal digital assistants (PDA's), portable communication apparatus, smart phones or the like.

### BRIEF DESCRIPTION OF THE DRAWINGS

The foregoing and other embodiments of the invention are hereinafter discussed with reference to the drawings. The components in the drawings are not necessarily to scale, emphasis instead being placed upon clearly illustrating the principles of the present invention. Likewise, elements and features depicted in one drawing may be combined with elements and features depicted in additional drawings. Moreover, in the drawings, like reference numerals designate corresponding parts throughout the several views.

FIG. 1 is an exemplary block diagram of a digital rights management system.

FIG. 2 is an exemplary block diagram of an award system for distributing digital content in accordance with aspects of the present invention.

FIGS. 3 and 4 are exemplary digital content files in accordance with aspects of the present invention.

FIG. 5 is an exemplary award database in accordance with aspects of the present invention.

FIGS. 6, 7 and 8 are exemplary schematic diagrams illustrating electronic equipment in accordance with aspects of the present invention.

FIG. 9 is an exemplary method in accordance with aspects of the present invention.

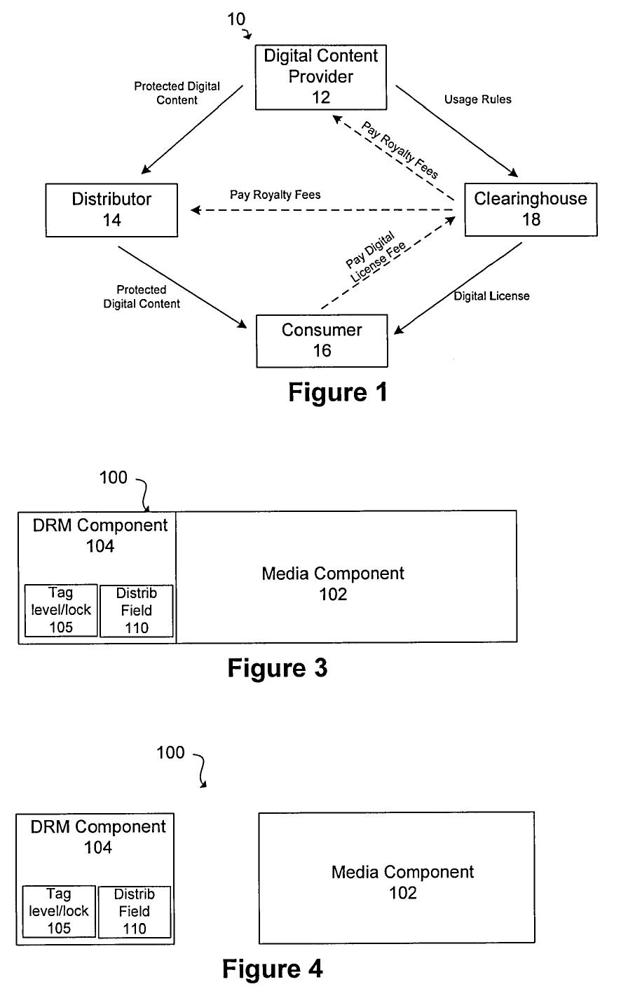

### DETAILED DESCRIPTION OF EMBODIMENTS

Aspects of the present invention are directed to a system and method for earning award points for distributing electronic digital content between electronic equipment. Generally, digital content (protected and un-protected) is stored on a remote distribution server. The digital content may be transmitted to and received by a receiving electronic equipment (e.g., portable communications devices including mobile telephones, computers, etc.). The digital content generally includes a header having one or more digital rights management fields for allowing access to the digital content based upon a content provider's preferences. Prior to the operator of the receiving electronic equipment distributing the digital content to one or more other electronic equipment, a unique identifier associated with the receiving electronic equipment is inserted in one or more of the digital rights management fields of the digital content. The digital content is then distributed containing the unique identifier. An identification associated with the digital content and the unique identifier associated with the receiving electronic equipment is subsequently transmitted to a provider upon distribution of the digital content. The provider generally maintains a record of a number of times the digital content was distributed and the unique identifier associated with distributing the digital content for an awards program based at least in part on distribution of the digital content.

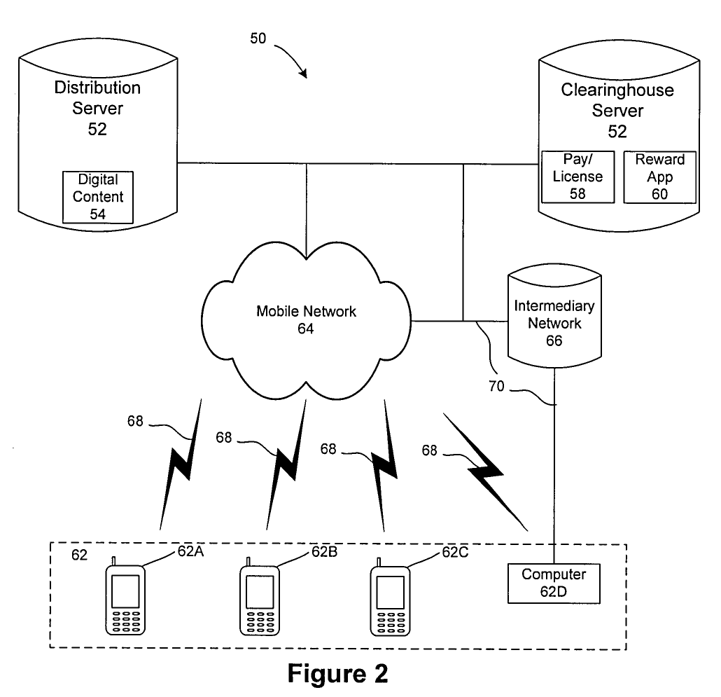

Referring to FIG. 2, an exemplary system 50 in accordance with aspects of the present invention is illustrated. The system 50 includes one or more of the following components: a distribution server 52 for storing and downloading digital content 54; a clearinghouse server 56 that performs a variety of functions, including for example, a payment verification and digital license application 58 and a rewards program application 60 stored on the server 56 and/or communicatively coupled to the server 56; and a plurality of electronic equipment 62 (identified in dashed line) for receiving digital content 54 from the distribution server 52. The distribution server 52, clearinghouse server 56 and electronic equipment 62 are communicatively coupled to one another generally by one or more networks (e.g., mobile network 64 and/or intermediary network 66) by wireless communication links 68 and/or wired communication line 70. One of ordinary skill in the art will readily appreciate that the precise architecture of the system may vary greatly depending on a variety of factors, network provider, types of electronic equipment supported, communication protocols, type of digital content to by exchanged, etc.

The distribution server 52 may acquire the digital content in any desired manner. For example, the transfer of digital content may involve an electronic transfer of the digital content from the content provider to an appropriate content distribution server 52, for example, a web server, a telephony server, a streaming file server, file transfer protocol (FTP) server, etc. for on-line distribution of the digital content 54. The distribution server 52 generally performs the same functions as distributor 14, discussed above. The distribution server 52 may be any device capable of storing digital content 54. Such devices include, for example: a network server, hard disk drives, memory, removable storage devices (e.g., DVDs, CD-ROM's, etc.) or any other suitable device. The distribution server 52 is capable of storing any desired type of digital content 54.

The digital content 54 may be any type of digital media, including, for example, music, images, video, books, multimedia content, games, ring tones, vouchers advertisements, and the like. The digital content may be protected and/or un-protected by a digital rights management scheme. For purposes of this disclosure, the phrase “digital content” should be given its broadest meaning and includes all media that can be stored in a digital format.

As used herein distribution of digital content also includes the distribution of uniform resource locators (URLS) and returns a rights object acquisition protocol (ROAP) trigger that enables and/or activates rights requests and registration requests from service providers, media distributors, content providers and/or advertising agencies. In another embodiment of the present invention, the user may forward digital content through exchanging memory storage devices between equipment. That is, the user may transfer a digital content file from one mobile phone to another personal computer, audio and/or video player, etc. through exchanging the memory card, memory disk, hard drive, USB, Mass storage device or through a messaging service, such as Bluetooth, Infrared, MMS, SMS, Email, etc.

In order to prevent widespread unauthorized copying and/or dissemination of the digital content 54, the digital content 54 may include a digital rights management (DRM) component. A DRM system generally provides a container format that may include a variety of information (e.g., album and track titles or other desired information depending on the type of digital content) and a set of permissions for enforcing copyright compliance that players generally support in order to play back the digital content. As stated above, a DRM system may be configured to allow digital content to expire (or otherwise left un-renderable), for example, after the digital content has been run (or viewed) a predetermined number of times, on a particular date, or when the subscription has expired, etc.

Referring to FIG. 3, an exemplary digital content file 100 is shown. The exemplary file 100 includes a digital content media component 102 and a digital rights management (DRM) component 104. As one of ordinary skill in the art will readily appreciate, the digital content media component 102 may be encrypted, un-encrypted and/or a combination of encrypted and un-encrypted. The digital content media component 102 is the portion of the of the file 100 that contains the content to be distributed for consumption. The DRM component 104 may include a header integrated with the digital content media component 102, as shown in FIG. 3. Likewise, the DRM component 104 may be a separate file, as shown in FIG. 4.

The DRM component 104 may perform all the digital rights management functions discussed herein, including, for example, identify the ownership of the digital content and the usage permissions associated with the digital content. The DRM component 104 may also include usage permissions. The usage permissions generally determine the conditions under which a user can play back the digital content. Usage permissions typically prevent copying or limit the number of times the content will play. Generally, the operating system of the electronic equipment 62 works with the multimedia middleware (e.g., media player, browser, etc.) to enforce these permissions. In another embodiment, the DRM component 104 may also include a tag level and lock and/or delete feature 105, which limits the user brought on by the number of file sharing exchanges the digital content has had. For example, after the file has been exchanged or otherwise distributed five times, the file is tagged to (a) delete itself; (b) become forward lock; or (c) change DRM protection type, notify the content provider on user acquiring licences that the file has expired and offers the user another (replacement) file to distribute for rewards, etc.

The DRM component 104 may include a tag level and lock and/or delete field 105 in the header of the digital content to prevent further distribution of the digital content after the digital content has been forwarded a predetermined number of times and/or after an expiration date has passed and the user may informed by a message from the content provider. The tag level and lock/delete field 105 may be located in the DRM component 104 of the digital content to prevent further distribution of the digital content after the digital content has been forwarded a predetermined number of times. In addition, the DRM component may include a tag level and lock/delete field 105 to delete the digital content after the digital content has been forwarded a predetermined number of times.

The content provider may offer a user that has content that has been locked and/or expired the ability to acquire a different file for distribution when this user goes to acquire the license for the file, thereby creating another user/distributor. For example, an advertisement with an offer, which has now become outdated (e.g. the offer has expired). The new recipient attempts to get the license and although the license cannot be acquired by the user under the expired offer, the content provider may offer a replacement with a rewards scheme attached. This creates a larger distribution chain and creates an excellent advertising opportunity with reward potential for the user/distributor. In other words, the distributor makes use of the contacts created by a previous campaign.

Generally, the DRM component 104 also includes a payment directive incorporated in the rights object (RO) 106. As discussed above, the digital content file 100 is generally available to be downloaded freely, but when the user attempts to render the content for the first time, the player of the rendering equipment detects a payment directive. A payment procedure may then be initiated using a defined telecommunications and/or network bearer. Preferably, the user is asked to confirm that the payment should be made, before the payment procedure proceeds. One aspect of the present invention provides that the user may forward the file to other recipients without actually purchasing the media themselves.

Referring to FIG. 3, the DRM component 104 further includes a distribution field 110 that tracks a unique identifier and/or parameter of the electronic equipment that distributed the digital content file 100. The distribution field 110 may be a fixed length or a variable length field. An application executed on the distributing electronic equipment generally inserts and/or appends the unique identifier and/or parameter of the distributing electronic equipment to the distribution field 110. This allows for tracking the distribution of the digital content file 100, as discussed below. This also allows for establishing a rewards program that rewards user's of electronic equipment an award for distribution of the digital content file in or order obtain greater distribution of the digital content file 100. The unique identifier may be a SIM card serial number for the electronic equipment, a telephone number associated with the electronic equipment, a social security number associated with the user of the electronic equipment, etc.

The distribution field 110 may take any desired form. For example, the field 110 may track all distributions of the digital content file 100 or may only track a predetermined amount of distributions, for example the first five distributors of the content file 100 or the last ten distributors of the content file 100. One of ordinary skill in the art will readily appreciate that the precise details associated with the number of distributors of the content file 100 may vary depending on a variety of parameters, for example, the type of distribution preferred by the content provider, the number of distributors that are to be awarded for distribution of the content by the content provider and/or the clearinghouse provider, etc.

The distribution field 110 is generally considered a multilevel distribution tag. A multilevel distribution tag generally means that a file being received by the rights object acquisition protocol (ROAP) is appended (i.e., tagged in the header) the moment it arrives. The distribution level (e.g., number of file sharing exchanges) will be tagged in the header of the file, which will generally provides an identification of how many times the digital content has been forwarded since its original recipient sent the file. This information is sent back to the clearinghouse 56, distributor 52, and/or content provider to assess the effectiveness of its recipients/distributors in marketing the digital content material.

As stated above, once the digital content file 100 is downloaded to the electronic equipment, when the user attempts to render the content for the first time, the player of the rendering electronic equipment may detect a payment directive. If there is no payment directive, the digital content may be rendered to the user. If the content is a demo and/or free-to-try digital content, the usage rights are verified to determine if the user has exceeded the usage rights. If the usage rights have been exceeded and/or the digital content requires payment, a payment procedure may then by initiated using a defined telecommunications and/or network bearer. The clearinghouse server 56 generally includes a payment/license application 58 that controls securing payment from the user of the electronic equipment for a digital license and transfer of the digital license to the paying electronic equipment. The digital license generally contains digital content licenses, if necessary, and usage permissions for the protected digital content. To be able to consume or otherwise render the protected content, the user requests a valid digital license from the clearinghouse 18. After receiving the license request, the clearinghouse 18 generally verifies the user's identity for example by having the user present a valid digital certificate, charges the user's account based on the content usage permissions, and generates transaction reports to the content provider 12. The digital license is then delivered to the consumer's device after the consumer has paid through an appropriate e-commerce system or added to the network charge through the network operator's billing system or other system and the protected content can be decrypted and used or otherwise rendered according to the usage rights in the license. In one embodiment, the clearinghouse generally tracks the license acquisition date of any new license purchaser for a variety of purposes, including to track expiration dates for the license, a ‘sell by date’ for the license (e.g., expiration date of a money off voucher and/or an advertising campaign that has stopped, etc.).

The clearinghouse server 56 may also include a reward program application 60. The reward program application 60 generally allows the user of electronic equipment 62 to earn awards and/or points to be redeemed for awards based on distribution of digital content to other electronic equipment. For purposes of this application, any item of value and/or recognition may be considered an award. Exemplary awards may include, reducing the cost of mobile telephony services, receive free and/or discounted digital content, receive items (e.g., a recorder, video player, television, etc.), receive private and/or public recognition regarding quantity and/or quality of distribution services, money off vouchers, etc. In addition, the awards may also be earned by attracting additional recipients. The reward program application 60 may be in the form of a database, a spreadsheet, and the like.

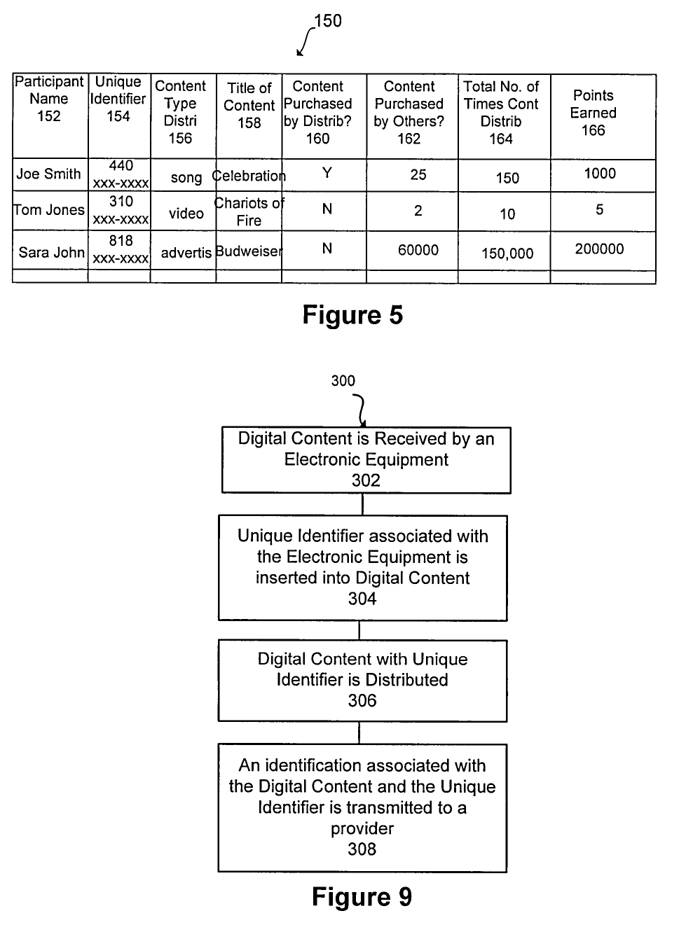

In one embodiment, the reward program application 60 maintains a listing of participant names and associated unique identifier, as specified above. An exemplary reward database 150 is shown in FIG. 5. The reward database 150 may track any desired information. Exemplary tracked information includes, for example, participant name 152, unique identifier 154, type of content distributed 156, title of content 158, content purchased by participant, 160, content purchased by others from distribution by participant 162, total number of distribution 164, points earned 166, etc. Generally multiple columns and/or rows of information may be desired to maintain and/or otherwise monitor the rewards program. As shown in FIG. 5, three participants in the award program are illustrated (e.g., Joe Smith, Tom Jones and Sara John). Each of the participants have a unique identifier 154 (e.g., 440 xxx-xxxx, 310 xxx-xxxx and 818 xxx-xxxx). The participants have distributed a variety of different media types 158 including songs, video, vouchers and advertisements. The title of the media content is provided in the column titled 158. Column 160 identifies whether the distributor purchased the digital content. Column 162 identifies how many users that the participant distributed the digital content actually purchased the digital content. Column 164 identifies how many times the content distributed by the participant was distributed. Column 166 identifies the total number of points earned for distribution of the particular digital content for each participant. One of ordinary skill in the art will readily appreciate that a wide range of parameters may be monitored, stored and/or calculated. The examples and format of the database 150 is not intended to limit the scope of the appended claims. In addition, the structure of the database 150 may have a variety of formats depending on a particular design choice.

The reward program application 60 generally allows the user to earn a predetermined amount of credit and/or points to redeem an award. Credit or points may be earned in any manner desired. For example, a participant may earn rewards for distributing the digital content. The participant may earn an increase in the reward if persons along the participant's distribution chain purchase and/or distribute the digital content. A benefit to this reward program is that operators will get access to many more electronic equipment than those on a particular network, which will enable the operator to digital content far beyond their original scope and customer base. At the same time, users of electronic equipment have an incentive to distribute the digital content.

Users of electronic equipment 62 may pass along received digital content to other electronic equipment through superdistribution. For example, digital content received by electronic equipment 62A may be transferred to any type of electronic equipment, without direct involvement of the distributor and/or content provider. As stated above, while the digital content can be freely distributed, the content is generally encrypted and to render the content, the recipient has to contact the clearinghouse and provide the necessary information and/or payment required to obtain the digital license. Therefore, control of digital content is generally maintained without any or limited distributor 52 oversight.

As stated above, users are not required to purchase digital content that they are distributing. In one embodiment, the license could be released to a distributor that did not pay for a particular license if people they have distributed to end up buying the license for the content they have distributed. In other words, the first recipient does not have to pay for the license as long as someone they distributed the media to does. The first distributor/user of the original media file may benefit from the new distributors' distributions. The new user acquiring the content may not necessarily be buying the license—they may just have to register the media to append the tracking system.

Multiple distribution levels of consumers may (if permitted by the content provider, distributor and/or clearinghouse) purchase more licenses after a particular digital content has run out (of time/expired). Such a mechanism may provide a distributor with multiple opportunities to obtain a wider distribution of digital content, as well as content providers, distributors, clearinghouses and individual users with the potential for revenue, benefits and rewards. For example, when the user/consumer simply registers the content with another device belonging to the original recipient or re-applying for the license for an expired file, or extending the license for an existing file with an existing valid license—all could generate points. In other words the user may have several devices registered within a domain. Passing the file from one device and acquiring the license, then passing to another device and then acquiring the license. The user may only pay once, then register the other devices for the same license. But passing the file to several machines may at least acquire points for distribution.

The amount of times the file has been forwarded, may acquire points for rewards, which do not generate buyers of licenses. The distribution through levels without purchase may mean that the name of a product as the file name may be advertising enough (for points) without the recipient actually buying the licenses to open the file—brings/should bring an advertising benefit in itself. For example: the file name may be a business name—giving the business exposure (e.g. file name is WallMartVouchers.dcf). In another example: a second level distributor (the file has come from a friend—who says “Hey, send this to Maria as a present for her birthday”) may not be interested in the file themselves—but may decide that someone they know may be better suited as a purchaser of the licenses, creating a third level purchaser. For example, the purchased licenses may be for a printable file containing money off vouchers for a retail shop—that the second recipient (or the first)—does not shop at. Contrary to this, the amount of times the file has been forwarded may not acquire rewards, but more-so the amount of times the file has been bought by the recipients—the file has been distributed to. In other words, the first recipient may distribute to one level and that one level may produce many purchasers. On the other hand, the first recipient may distribute through many levels but only create one or two purchasers—both are beneficial to marketing.

There are a variety of alterations that may be made to the above system. For instance, the digital license can be delivered to the requesting application prior to or at the same time as the transfer of digital content. This can apply to temporary licensing for promotional purposes. For example, a temporary license specifying a three-time access for a piece of digital music could be pre-delivered with the media, allowing the consumer to listen to the music three times and then making decision to request and paying for a permanent license allowing unlimited accesses. Some companies offer ‘try-before-buy’ business model that directs the consumer to the clearinghouse where a permanent license can be purchased after the temporary license expires.

When the operator of the electronic equipment 62 has earned a reward and/or earned enough points to select an award, the operator may log in to a web site maintained by or otherwise associated by the clearinghouse 56. The operator may be prompted to log in the associated website and select a desired award. As stated above, an award may be reducing the cost of mobile telephony services, receive free and/or discounted digital content, receive items (e.g., a recorder, video player, television, etc.), receive private and/or public recognition regarding quantity and/or quality of distribution services, etc. In addition, the operator may mail in an application for an award using conventional mail. One of ordinary skill in the art will readily appreciate that there are a variety of manners for a user to select and/or otherwise obtain a desired reward.

Referring back to FIG. 2, electronic equipment 62 are shown in accordance with aspects of the present invention. The illustrated electronic equipment 62 includes any type of electronic equipment (e.g. mobile telephones, personal digital assistants, computers, etc.) Electronic equipment 62A-6C, in the exemplary embodiment, are mobile telephones and will be referred to as mobile telephones. Likewise electronic equipment 62D is a computer and will be referred to as a computer. The mobile telephones 62A-62C may communicate with the distribution server 52 and the clearinghouse server 56 through the mobile network 64. Likewise, the computer 62D may communicate with the distribution server 52 and the clearinghouse server 56 through the mobile network 64, if so equipped, or through an intermediary network 66.

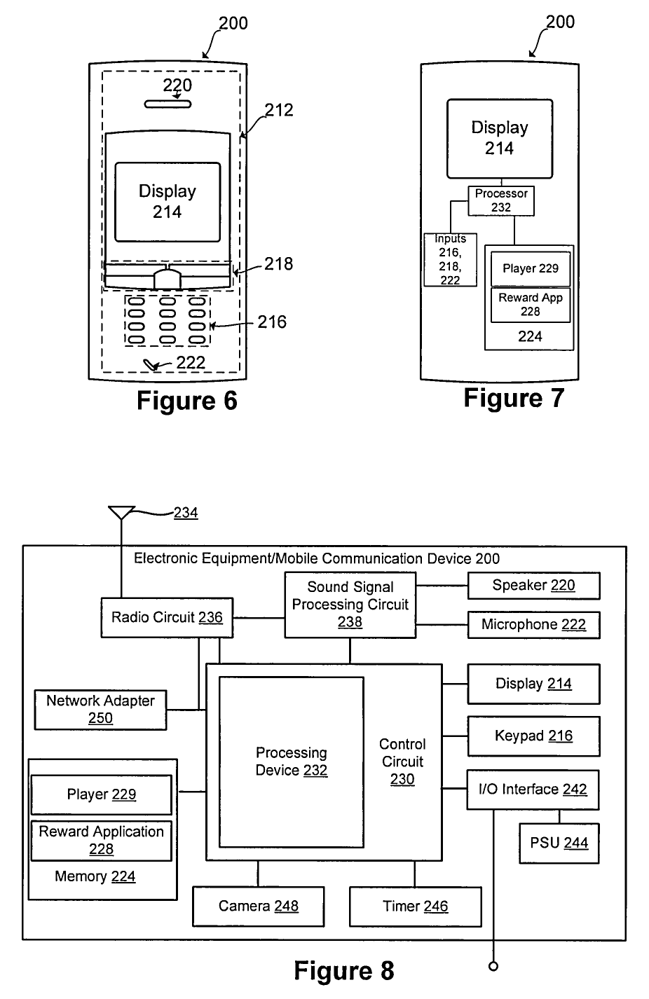

For purposes of this disclosure, the functions of the mobile telephone 62A-62C related to the present invention will be substantially identical to computer 62D. Therefore, for the sake of brevity, only operation of an exemplary mobile telephone 200 (FIG. 6) will be discussed. Referring to FIG. 6, the mobile telephone 200 (also referred to herein as mobile communications device) may include a user interface 212 (identified by dotted lines) that enables the user easily and efficiently to perform one or more communication tasks (e.g., identify a contact, select a contact, make a telephone call, receive a telephone call, request digital content from a remote server, etc). The user interface 212 of the mobile telephone 200 generally includes one or more of the following components: a display 214, an alphanumeric keypad 216, function keys 218, a navigation tool 219, a speaker 220, and/or a microphone 222.

The mobile telephone 200 includes a display 214. The display 214 displays information to a user such as operating state, time, telephone numbers, contact information, various navigational menus, status of one or more functions, etc., which enable the user to utilize the various features of the mobile telephone 200. The display 214 may also be used to visually display content accessible by the mobile telephone 200. The displayed content may include E-mail messages, audio and/or video presentations stored locally in memory 24 (FIG. 7) of the mobile telephone 200 stored remotely from the mobile telephone 200 (e.g., on a remote storage device, a mail server, remote personal computer, etc.) and/or downloaded digital content having digital rights management. Such presentations may originate, be derived and/or downloaded from any source. For example, from multimedia files downloaded from a remote server, from multimedia files received through E-mail messages, including audio and/or video files, from a received mobile radio and/or television signal, etc. The audio component may be broadcast to the user with a speaker 200 of the mobile telephone 200. Alternatively, the audio component may be broadcast to the user though a headset speaker (not shown).

The mobile telephone 200 further includes a keypad 216 that provides for a variety of user input operations. For example, the keypad 216 may include alphanumeric keys for allowing entry of alphanumeric information such as user-friendly identification of contacts, user-friendly identification of contacts, E-mail addresses, distribution lists, telephone numbers, phone lists, contact information, notes, etc. In addition, the keypad 216 typically may include special function keys such as a “call send” key for transmitting an E-mail, initiating or answering a call, and a “call end” key for ending, or “hanging up” a call. Special function keys may also include menu navigation keys, for example, for navigating through a menu displayed on the display 214 to select different telephone functions, profiles, settings, etc., as is conventional. Other keys associated with the mobile telephone 200 may include a volume key, audio mute key, an on/off power key, a web browser launch key, an E-mail application launch key, a camera key, etc. Keys or key-like functionality may also be embodied as a touch screen associated with the display 214.

As shown in FIG. 7, the mobile telephone 10 further includes one or more storage devices 224 (e.g., RAM, ROM, etc.) capable of storing application software 226, including a reward participant application 228 and a player 229. The application software 226, the reward participant application 228 and/or the player 229 are coupled to a processor 232 for execution. The processor 232 is programmed to perform the functionality described herein, for example, controlling one or more software applications, receiving and storing user input, etc. In operation, the reward participant application 228 is executed when the user of the mobile telephone 200 receives digital content. For example, when the user of the mobile telephone 200 receives digital content and/or desires to distribute digital content, the reward participant software appends and/or inserts a unique identifier associated with the electronic equipment 200 to the distribution field 110. In addition, the reward participant application 228 also causes information (e.g., type of digital content, unique identifier for the digital content, unique identifier for the electronic equipment and/or user, etc.) to be transmitted to the clearinghouse server 56 for storage and/or recordal in the reward program application 60.

The processor 232 also is coupled with conventional input devices (e.g., user input device 216, function keys 218, navigation tool 219, microphone 222, etc.), and to the device display 214 and the speaker 220. The user interface 212 facilitates controlling operation of the mobile telephone 200 including initiating and conducting telephone calls and other communications (e.g., SMS communications, Internet communications, etc.). The mobile telephone 200 also includes conventional call circuitry (FIG. 8) that enables the mobile telephone 200 to establish a call, transmit and/or receive E-mail messages, and/or exchange signals with a called/calling device, typically another mobile communications device or landline telephone. However, the called/calling device need not be another telephone, but may be some other electronic device such as an Internet web server, E-mail server, content providing server, etc.

Referring to FIG. 8, an exemplary functional block diagram of the mobile telephone 200 is illustrated. The mobile telephone 200 includes a primary control circuit 230 that is configured to carry out overall control of the functions and operations of the mobile telephone 200. The control circuit 230 may include a processing device 232, such as a CPU, microcontroller or microprocessor. The processing device 232 executes code stored in a memory (not shown) within the control circuit 230 and/or in a separate memory, such as memory 224, in order to carry out operation of the mobile telephone 200. The processing device 232 is generally operative to perform all of the functionality disclosed herein. For example, the processing device 232 is coupled to the storage element (e.g., memory 224), reward participant application 228 and/or digital content player 229 for detecting DRM schemes and verifying digital license and usage terms. The memory 224 may be, for example, a buffer, a flash memory, a hard drive, a removable media, or some other type of volatile and/or a non-volatile memory. In addition, the processing device 232 executes code to carry out various functions of the mobile telephone 200.

The mobile telephone 200 includes an antenna 234 coupled to a radio circuit 236. The radio circuit 236 includes a radio frequency transmitter and receiver for transmitting and receiving signals via the antenna 234 as is conventional. The mobile telephone 200 generally utilizes the radio circuit 236 and antenna 234 for voice, Internet and/or E-mail communications over a cellular telephone network. The mobile telephone 200 further includes a sound signal processing circuit 238 for processing the audio signal transmitted by/received from the radio circuit 236. Coupled to the sound processing circuit 238 are the speaker 220 and a microphone 222 that enable a user to listen and speak via the mobile telephone 200 as is conventional. The radio circuit 236 and sound processing circuit 238 are each coupled to the control circuit 230 so as to carry out overall operation.

The mobile telephone 200 further includes an I/O interface 242. The I/O interface 242 may be in the form of typical mobile communications device I/O interfaces, such as a multi-element connector at the base of the mobile telephone 200. As is typical, the I/O interface 242 may be used to couple the mobile telephone 200 to a battery charger to charge a power supply unit (PSU) 244 within the mobile telephone 200. In addition, or in the alternative, the I/O interface 242 may serve to connect the mobile telephone 200 to a wired personal hands-free adaptor, to a personal computer or other device via a data cable, etc. The mobile telephone 200 may also include a timer 246 for carrying out timing functions. Such functions may include timing the durations of calls, generating the content of time and date stamps, etc.

The mobile telephone 200 may include various built-in accessories, such as a camera 248 for taking digital pictures. Image files corresponding to the pictures may be stored in the memory 224. In one embodiment, the mobile telephone 200 also may include a position data receiver (not shown), such as a global positioning satellite (GPS) receiver, Galileo satellite system receiver or the like.

The mobile telephone 200 may also include one or more wireless network adapters 250 for establishing wireless communications with one or more remote devices and/or downloading digital content from distribution server 52 and communicating various information to clearinghouse server 56. The wireless network adapter 250 may be any suitable wireless network adapter. For example, wireless network adapter 250 may be a wireless local area network (WLAN) adapter, a Bluetooth adapter, a near field communication adapter, etc. In one embodiment, the wireless network adapter 250 is WLAN adapter that enables mobile telephone 200 to communicate with other nearby WLAN-equipped devices or WLAN access points. Preferably, the WLAN adapter 250 is compatible with one or more IEEE 802.11 protocols (e.g., 802.11(a), 802.11(b) and/or 802.11(g), etc.) and allows the mobile telephone 200 to acquire a unique address (e.g., IP address) on the WLAN and communicate with one or more devices on the WLAN and fixed local network and/or other devices located remotely from the WLAN (e.g., remote computers, mobile phones, etc.) using one or more protocols (e.g., Internet Protocol, VoIP, SMP, IM, etc.), assuming the user has the appropriate privileges and/or has been properly authenticated.

Among the one or more wireless network adapters, the mobile telephone 200 may also include one or more wireless wide-area network (WWAN) adapters that enable the mobile telephone 200 to communicate with compatible wide-area WWAN's based on technologies such as 2G or 3G cellular, WiMax, WiBro, or the like. The WWAN may include or be communicably coupled to a server or servers for managing calls, Internet access and/or E-mails placed by and/or destined to the mobile telephone 200, transmitting multimedia content (e.g., image files, audio files, video files, etc.) to and/or from the mobile telephone 200, downloading digital content from distribution server 52 and communicating various information to clearinghouse server 56 and carrying out any other support functions. The server generally communicates with the mobile telephone 200 via a network and a transmission medium. The transmission medium may be any appropriate device or assembly, including, for example, a communications tower, another mobile communications device, a wireless access point, a satellite, etc. Portions of the network may include wireless and/or wired transmission pathways.

The mobile telephone 200 may also be configured to operate in a wide area communications system (e.g. 3G, GPRS). The system can include a server or servers for managing calls, Internet access and/or E-mails placed by and/or destined to the mobile telephone 200, transmitting multimedia content (e.g., image files, audio files, video files, etc.) to and/or from the mobile telephone 200 and carrying out any other support functions. The server generally communicates with the mobile telephone 10 via a network and a transmission medium. The transmission medium may be any appropriate device or assembly, including, for example, a communications tower, another mobile telephone, a wireless access point, a satellite, etc. Portions of the network may include wireless transmission pathways.

The consumer applications that generally render the digital content (e.g., player 229) may be any type of digital content player. Exemplary applications include digital content viewers, players or readers, etc. These devices generally play a significant role in DRM implementation. The applications (e.g., player 229) generally enforce protection of digital content on the basis of the digital license. Most content providers extend existing viewers without DRM functionalities through the use of application plug-ins, which essentially makes those applications become integral components of DRM systems. In this approach, the content provider usually uses a special file extension to identify digital content protected by a specific DRM system. Through a particular plug-in, the content viewer opens and decrypts the digital content based on the usage permissions in the license. Generally each DRM system uses its own proprietary approach and there is no interoperability between application extensions and plug-ins. Digital content protected by one DRM system also generally cannot be accessed by the client-side application in another DRM system. To access various digital content provided by multiple DRM systems, the consumer has to install different plug-ins and vendor-specific applications.

Referring to FIG. 9, an exemplary method 300 for earning an award for distributing digital content between electronic equipment is illustrated. At step 302, digital content from an associated electronic source is received by a receiving electronic equipment. The source may be a distributor of the digital content. The digital content generally includes a header having one or more digital rights management fields. At step 304, a unique identifier associated with the receiving electronic equipment is inserted and/or appended in one or more of the digital rights management fields of the digital content. At step 306, the digital content containing the unique identifier is distributed to one or more electronic equipment. At step 308, an identification associated with the digital content and the unique identifier associated with the receiving electronic equipment is transmitted to a provider upon distribution of the digital content. The provider may be the distributor 52 and/or or clearinghouse server 56. The provider generally maintains a record of a number of times the digital content was distributed and the unique identifier associated with distributing the digital content for an awards program based at least in part on distribution of the digital content.

Specific embodiments of an invention are disclosed herein. One of ordinary skill in the art will readily recognize that the invention may have other applications in other environments. In fact, many embodiments and implementations are possible. The following claims are in no way intended to limit the scope of the present invention to the specific embodiments described above. In addition, any recitation of “means for” is intended to evoke a means-plus-function reading of an element and a claim, whereas, any elements that do not specifically use the recitation “means for”, are not intended to be read as means-plus-function elements, even if the claim otherwise includes the word “means”. It should also be noted that although the specification lists method steps occurring in a particular order, these steps may be executed in any order, or at the same time.

Computer program elements of the invention may be embodied in hardware and/or in software (including firmware, resident software, micro-code, etc.). The invention may take the form of a computer program product, which can be embodied by a computer-usable or computer-readable storage medium having computer-usable or computer-readable program instructions, “code” or a “computer program” embodied in the medium for use by or in connection with the instruction execution system. In the context of this document, a computer-usable or computer-readable medium may be any medium that can contain, store, communicate, propagate, or transport the program for use by or in connection with the instruction execution system, apparatus, or device. The computer-usable or computer-readable medium may be, for example but not limited to, an electronic, magnetic, optical, electromagnetic, infrared, or semiconductor system, apparatus, device, or propagation medium such as the Internet. Note that the computer-usable or computer-readable medium could even be paper or another suitable medium upon which the program is printed, as the program can be electronically captured, via, for instance, optical scanning of the paper or other medium, then compiled, interpreted, or otherwise processed in a suitable manner. The computer program product and any software and hardware described herein form the various means for carrying out the functions of the invention in the example embodiments.

What is claimed is:

1. A method for earning an award for distributing electronic content between electronic equipment, the method comprising:
receiving digital content from an associated electronic source by a receiving electronic equipment, wherein the digital content includes a header having one or more digital rights management fields;
inserting a unique identifier associated with the receiving electronic equipment in one or more of the digital rights management fields of the digital content;
distributing the digital content containing the unique identifier to one or more electronic equipment;
transmitting an identification associated with the digital content and the unique identifier associated with the receiving electronic equipment to a provider upon distribution of the digital content, wherein the provider maintains a record of a number of times the digital content was distributed and the unique identifier associated with distributing the digital content for an awards program based at least in part on distribution of the digital content.

2. The method of claim 1, wherein the digital content is at least one selected from the group consisting of: a music file, an image file, a video file, an electronic book file, an electronic video game, a ring tone file.

3. The method of claim 1, wherein the digital content is an advertisement for a product and/or a service.

4. The method of claim 1, wherein the digital content is a voucher.

5. The method of claim 1, wherein the receiving electronic equipment is a mobile telephone.

6. The method of claim 1, wherein the digital rights management fields includes a tag level and lock field in the header of the digital content to prevent further distribution of the digital content after the digital content has been forwarded a predetermined number of times and/or to prevent the user acquiring additional licenses for the media.

7. The method of claim 1, wherein the digital rights management fields includes a tag level and delete field in the header of the digital content to delete the digital content after the digital content has been forwarded a predetermined number of times and/or exceeded an expiration date.

8. The method of claim 1, wherein award points are accumulated for selection of an award.

9. The method of claim 8, wherein the award is selected from the group consisting of reduced wireless telephony service fees or reduced cost for digital content downloads.

10. The method of claim 8, wherein digital content distributed by the receiving electronic equipment and later purchased by a second receiving electronic equipment earns more awards points for the receiving electronic equipment than digital content distributed by the receiving electronic equipment.

11. The method of claim 1, wherein the header of the digital content includes a plurality of unique identifiers associated with electronic equipment that distributed the digital content.

12. The method of claim 11, wherein each of the electronic equipment identified in the header earn reward points based at least on distribution of the digital content.

13. The method of claim 11, wherein each of unique identifiers accumulates award points based on location of the unique identifier in the header of the digital content.

14. A system for earning an award for distributing electronic content between electronic equipment, the system comprising:
a server for storing digital content, wherein the digital content includes a header having one or more digital rights management fields;
a plurality of electronic equipment for receiving digital content from the server, wherein at least of the plurality of electronic equipment is capable of inserting a unique identifier associated with the receiving electronic equipment in one or more of the digital rights management fields of the digital content; and
a provider server communicatively coupled to the server and at least one of the electronic equipment for maintaining a record of a number of times the digital content was distributed and the unique identifier associated with distributing the digital content for an awards program based at least in part on distribution of the digital content.

15. The system of claim 14, wherein the digital rights management fields includes a tag level and lock field in the header of the digital content to prevent further distribution of the digital content after the digital content has been forwarded a predetermined number of times.

16. The system of claim 14, wherein the digital rights management fields includes a tag level and delete field in the header of the digital content to delete the digital content after the digital content has been forwarded a predetermined number of times.

17. The system of claim 14, wherein award points are accumulated for selection of an award.

18. The system of claim 14, wherein the header of the digital content includes a plurality of unique identifiers associated with electronic equipment that distributed the digital content.

19. A method for earning an award for distributing electronic content between electronic equipment, the method comprising:
receiving digital content from an associated electronic source by a receiving electronic equipment, wherein the digital content includes a header having one or more digital rights management fields;
appending a unique identifier associated with the receiving electronic equipment in one or more of the digital rights management fields of the digital content;
distributing the digital content containing the unique identifier to one or more electronic equipment;
transmitting an identification associated with the digital content and the unique identifier associated with the receiving electronic equipment to a provider upon distribution of the digital content, wherein the provider maintains a record of a number of times the digital content was distributed and the unique identifier associated with distributing the digital content for an awards program based at least in part on distribution of the digital content.

20. The method of claim 19, wherein the digital rights management fields includes a tag level and lock field in the header of the digital content to prevent further distribution of the digital content after the digital content has been forwarded a predetermined number of times.

21. The method of claim 19, wherein the digital rights management fields includes a tag level and lock field in the header of the digital content to delete the digital content after the digital content has been forwarded a predetermined number of times.

22. The method of claim 19, wherein the awards program includes awarding a predetermined amount of award points for distribution of digital content, wherein award points are accumulated for selection of an award.
